(19) United States
(12) Patent Application Publication
(10) Pub. No.: US 2023/0186606 A1
(43) Pub. Date: Jun. 15, 2023

(54) Tensor Collaborative Graph Discriminant Analysis Method for Feature Extraction of Remote Sensing Images

(71) Applicant: SOUTHWEST ELECTRONICS TECHNOLOGY RESEARCH INSTITUTE (CHINA ELECTRONICS TECHNOLOGY GROUP CORPORATION, Chengdu, Sichuan (CN)

(72) Inventors: Lei PAN, Chengdu, Sichuan (CN); Xiang DAI, Chengdu, Sichuan (CN); Lican DAI, Chengdu, Sichuan (CN); Ying CUI, Chengdu, Sichuan (CN); Lu YANG, Chengdu, Sichuan (CN); Weiqing CHEN, Chengdu, Sichuan (CN); Xiang GAO, Chengdu, Sichuan (CN)

(21) Appl. No.: 17/913,855

(22) PCT Filed: Mar. 8, 2021
(86) PCT No.: PCT/CN2021/079598

§ 371 Date: Sep. 23, 2022

(30) Foreign Application Priority Data
Aug. 30, 2020 (CN) 202010891063.6

(51) Int. Cl. G06V 10/771; G06V 10/426; G06V 10/58; G06V 10/774; G06V 10/764

(52) U.S. Cl. CPC G06V 10/771; G06V 10/426; G06V 10/58; G06V 10/774; G06V 10/764

(57) ABSTRACT

Provided is a method for feature extraction of a remote sensing image based on tensor collaborative graph discriminant analysis, including: taking each of pixels as a center for intercepting a three-dimensional tensor data block; dividing experimental data into a training set and a test set in proportion; computing a Euclidean distance between a current training pixel and each class of training data; configuring a L2 norm collaborative representation model with a weight constraint; acquiring a projection matrix of each dimension of each of the three-dimensional tensor data block; and utilizing a low-dimensional projection matrix to obtain a training set and a test set, expanding the training set and the test set into a form of column vectors according to a feature dimension, inputting extracted low-dimensional features into a support vector machine classifier for classification, to determine a class of the test set, and evaluating, by a classification effect, performance of feature extraction.

### TECHNICAL FIELD

The present disclosure relates to image feature extraction in the field of image processing, in particular to a graph discriminant analysis based technology for feature extraction of a remote sensing images, and in particular to a method for feature extraction of a remote sensing images based on tensor collaborative graph discriminant analysis.

### BACKGROUND

With a mass of high-dimensional and high-order data generated in a number of application fields, especially in cloud computing, mobile Internet and big data applications, the mathematical form of a tensor is employed to properly represent these data having multi-dimensional structures. These data often includes multiple redundant information, and accordingly, it is necessary to effectively reduce dimensions of these data. In pattern recognition, feature extraction (dimensionality reduction) and classification are two critical steps. Most of classical methods for feature extraction and classification are based on vector data, and accordingly, it is necessary to vectorize on the tensor data in response to the tensor data being processed. In the process of vectorizing the tensor data, the internal structure of the data will be destroyed, and the dimension will be significantly increased, resulting in significant increase in the amount of computation and complexity of the algorithm. Patterns in the form of tensors are often encountered in pattern recognition. For example, a gray image is a second-order tensor, and a color image is a third-order tensor. For the needs of processing, data is often artificially assembled in a tensor pattern. For example, data in environmental monitoring can be regarded as a third-order tensor taking time, positions and types as patterns, and patterns in the form of the tensor are used in network graph mining, network debate and face recognition. However, the data is generally represented in a vector pattern in traditional statistical pattern recognition. That is, regardless of whether original data is a one-dimensional vector, a two-dimensional matrix or a high-order tensor, the original data is always transformed into the corresponding vector pattern for processing. In order to facilitate effective analysis and research, it is often necessary to represent a given remote sensing images as simpler and clear values, symbols or graphs, which reflect basic important information in the image and is represented as image features. The image features serve as an essential basis of image analysis, and operation of obtaining image feature information is represented as feature extraction, which is extremely important as a basis of pattern recognition, image understanding or information content compression. Extraction and selection of the image features are considerably important links in the process of image processing, and have a profound impact on subsequent image classification. Image data features few samples and high dimensions, and accordingly, it is necessary to reduce the dimension of the image features in order to extract useful information from the image. Feature extraction and feature selection are the most effective method for reducing a dimension, the objective of which is to obtain a feature sub-space reflecting an essential structure of data and having a higher recognition rate.

With development of a remote sensing technology, the number of bands capable of obtaining the remote sensing images keeps increasing, which provides extremely rich remote sensing information to understand physical objects, thereby contributing to completing more detailed classification and target recognition of remote sensing physical objects. However, redundancy of information and increase in data processing complexity are necessarily caused by increase in the bands. Although each kind of image data possibly includes some information for automatic classification, not all the obtained band image data are available for classification of some specified physical objects. With spectral differences of the same class in the image, a training sample is not well representative. It is necessary to select and evaluate the training sample with considerable manpower and time. In response to a number of original images being directly used to classified without distinction, not only the amount of data will be fairly sizable, computation will be complex, but also the classification effect will be less satisfactory. Since spectral features of each class in the image will be changed with time, terrain, etc., spectral cluster groups between different images and images during different periods cannot maintain continuity, thereby making comparison between different images difficult. The traditional mode of manually interpreting a remote sensing images has been extremely difficult to apply, which is replaced with a method for automatically extracting remote sensing images information by a computer. However, the corresponding data processing algorithm generally has the defect of insufficient adaptive capability. In order to effectively achieve classification and recognition, it is necessary to transform original sampled data to obtain features that can best reflect the essence, which is a process of feature extraction and selection. The so-called feature extraction of a hyperspectral image is to reduce the dimension of the spectral dimension on the basis of removing redundancy and retaining effective information, so as at least to reduce complexity of data. The classification of the hyperspectral image is to utilize different ground objects having different spectral feature information, to distinguish classes of different ground objects in the image.

The hyperspectral remote sensing earth observation technology provides refined image data for ground object detection. The hyperspectral image is a multi-spectral image, which includes dozens or even hundreds of continuous bands having rich spectral features. These data not only includes rich ground object spectral information, but also includes spatial structural information having increasingly high resolution. However, redundancy of information and increase in data processing complexity are necessarily caused by increase of bands. These bands of the hyperspectral image have strong correlation, which not only brings great information redundancy, but also increases computation burden of hyperspectral data classification. In addition, the “Hughes phenomenon” (which is also known as the curse of the dimension) caused by the high dimension and small number of samples also makes hyperspectral data classification more challenging. Therefore, feature extraction has become a critical preprocessing step in hyperspectral image analysis.

Generally, feature extraction methods are roughly divided into an unsupervised type and a supervised type according to whether to use prior information of the sample. Principal component analysis (PCA) is the most classical unsupervised method for feature extraction, the objective of which is to find a linear transformation matrix that maximizes the variance of data, so as at least to retain important information included in the data in low-dimensional features obtained by projection. Since the prior label information of the sample is not used, it is usually difficult for performance of the unsupervised method to satisfy the needs of practical applications. In order to utilize prior information of the data to further improve the performance of data processing, scholars have done multiple research in supervised feature extraction. Linear discriminant analysis (LDA) is the most classical supervised method for feature extraction, the objective of which is to find a projection transformation to maximize a Fisher ratio as a Rayleigh quotient in the sub-space obtained by projection, so as to at least enhance separability of low-dimensional features. However, in the case of a small sample size (SSS), the LDA usually has poor performance. In hyperspectral remote sensing images classification, since the number of training samples is often far less than the spectral feature dimension, direct use of the conventional linear discriminant analysis algorithm will necessarily encounter the above problem of the small sample size. In order to solve the problem, researchers have proposed multiple discriminant analysis methods on the basis of the LDA. With successful application of sparse representation (SR) in face recognition, multiple researchers have introduced the SR into the field of feature extraction and classification of the hyperspectral image, proposed sparse graph embedding, sparse graph-based discriminant analysis and other methods, and made a great breakthrough in performance of feature extraction. Later, a low-rank graph embedding method is provided on the basis of a low-rank representation theory.

In fact, the methods for feature extraction mentioned above are all developed on the basis of a vector space, and a spectral vector is usually taken as a basic research unit in hyperspectral image analysis. However, the research shows that spatial information has an vital effect in hyperspectral image processing. The full use of spatial structural information of the hyperspectral image can improve performance of feature extraction and classification of the hyperspectral image. Accordingly, it has become a research hot spot to carry out research on feature extraction of the hyperspectral image in combination with spatial information. The early spatial spectral feature based methods for reducing a dimension consider spatial information and spectral information at the same time. Although these methods bring performance improvement to a certain extent, it is necessary for these methods to transform spatial spectral features into the form of the vector for analysis, such that spatial connection between local pixels is usually lost.

Although multiple feature extraction methods have been provided, existing feature extraction methods are basically still in an experimental stage, which accuracy, practicality, versatility and other aspects are still far from the requirements of large-scale practical applications. To sum up, the existing feature extraction methods for a hyperspectral image still have two problems: (1) a feature extraction method model has too high complexity, and L1 norm based sparse graph embedding and nuclear norm based low-rank graph embedding involve a complex solution process in the process of solving a graph weight matrix; (2) spatial information of the hyperspectral image is not sufficiently used, some methods maintain local information of pixels by local regularization, and utilization of spatial information has limitations.

### SUMMARY

At least some embodiments of the present disclosure provide a supervised method for feature extraction, with low complexity and excellent feature extraction performance, so as to at least partially solve the problems of a high spectral dimension and large information redundancy of hyperspectral data, high complexity and insufficient spatial information mining of an existing method, etc. in the related art.

In an embodiment of the present disclosure, a method for feature extraction of a remote sensing images based on tensor collaborative graph discriminant analysis is provided. The method includes:

firstly, setting a size of a square sliding window, taking a first pixel of hyperspectral data as a starting point, and taking each of pixels as a center for intercepting a three-dimensional tensor data block; dividing experimental data into a training set and a test set in proportion according to the obtained tensor data blocks, and expanding each of the data blocks into a column vector according to a spectral dimension; computing a Euclidean distance between a current training pixel and each class of training data, to construct a diagonal weight constraint matrix; then designing an L2 norm collaborative representation model having a constraint, to compute a representation coefficient of the current training pixel under each class of training data, so as to construct a graph weight matrix and a tensor locality preserving projection model; working out a projection matrix of each dimension of the corresponding tensor data block by means of the tensor locality preserving projection model; and utilizing a low-dimensional projection matrix to obtain a training set and a test set which are represented by three-dimensional low dimensions, expanding the training set and the test set into a form of column vectors according to a feature dimension, inputting extracted low-dimensional features into a support vector machine classifier for classification, to determine a class of the test set to obtain a determination result, and evaluating the performance of feature extraction by a classification effect of the determination result.

Compared with the related art, the embodiment of the present disclosure has the technical effects:

(1) The embodiment of the present disclosure constructs a tensor collaborative graph discriminant analysis based feature extraction model from algorithm complexity and spatial information mining, and the technology focuses on advanced mathematical theories of an L2 norm sparse constraint, a weight constraint matrix, tensor representation, etc., and provides an optimization solution of the feature extraction model.

(2) The embodiment of the present disclosure utilizes an L2 norm to construct the collaborative representation model with a constraint, to solve a representation coefficient of each of the pixels in the training set. Compared with a sparse graph-based discriminant analysis model, the collaborative representation model based on L2 Norm may obtain closed-form solution by means of model derivation, thereby avoiding high complexity of solution of an orthogonal matching tracking method of an L1 norm in the sparse graph model; and compared with a collaborative graph discriminant analysis model, the embodiment of the present disclosure configures the weight constraint matrix, such that the model may be constrained to select training data similar to a current pixel as much as possible, thereby improving quality of the representation coefficient.

(3) The embodiment of the present disclosure takes a mathematical theory of tensor analysis as a tool, and uses a tensor representation method to mine spatial structural information of hyperspectral data for some problems existing in tensor data based feature extraction and classification algorithms. The hyperspectral data is a three-dimensional stereo data consisting of two spatial dimensions and one spectral dimension, which extremely matches a third-order tensor. Therefore, the tensor data block is used for collaborative representation calculation, such that spatial neighborhood information of data may be better reserved, thereby improving accuracy of the representation coefficient.

The core of the embodiment of the present disclosure is to construct the tensor collaborative representation model having a weight constraint, to effectively capture spectral information and spatial information of the hyperspectral data, and improve discrimination capability of low-dimensional features. The present disclosure is effective in response to image feature extraction or dimensionality reduction being involved. Simulation experiments show that the embodiment of the present disclosure is obviously superior to a sparse graph-based discriminant analysis method, a collaborative graph discriminant analysis method and other spatial spectral methods for feature extraction on performance of feature extraction of a hyperspectral image.

The embodiment of the present disclosure is suitable for feature extraction of the hyperspectral image.

### BRIEF DESCRIPTION OF THE DRAWINGS

FIG. 1 is a schematic diagram of tensor collaborative graph discriminant analysis based feature extraction method for remote sensing images according to an embodiment of the present disclosure;

FIG. 2 is a flow chart of tensor collaborative graph discriminant analysis method for image feature extraction according to an embodiment of the present disclosure;

FIG. 3 is a schematic diagram of expansion of a module three of a three-order tensor according to an embodiment of the present disclosure;

In order to make the objectives, technical solutions and advantages of the present disclosure clearer, the present disclosure will be further described in detail below in combination with particular embodiments with reference to the accompanying drawings.

### DETAILED DESCRIPTION

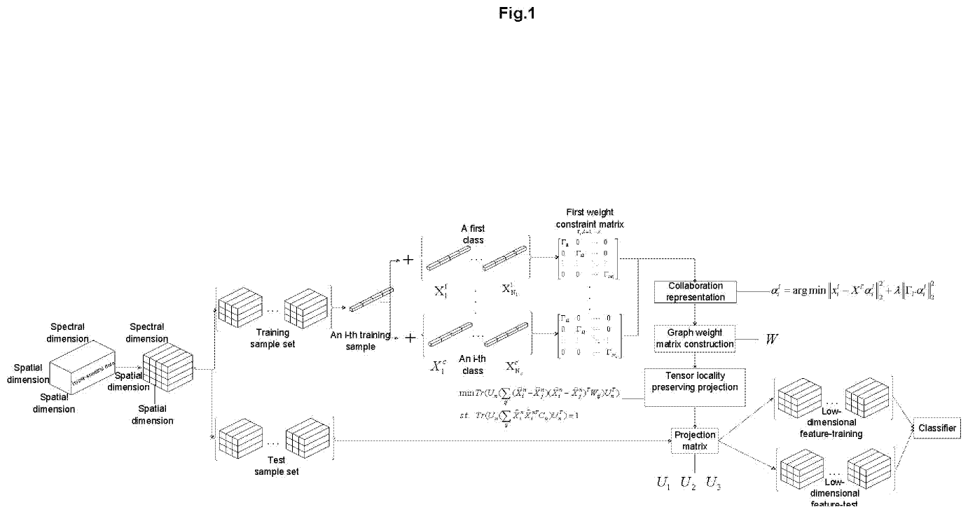

With reference to FIGS. 1-3, an embodiment of the present disclosure includes: firstly, set a size of a square sliding window, take a first pixel of hyperspectral data as a starting point, and take each of pixels as a center for intercepting a three-dimensional tensor data block; divide experimental data into a training set and a test set in proportion according to the obtained tensor data blocks, and expand each of the data blocks into a column vector according to a spectral dimension; compute a Euclidean distance between a current training pixel and each class of training data, to construct a diagonal weight constraint matrix; then configure an L2 norm collaborative representation model with a constraint, to compute a representation coefficient of the current training pixel under each class of training data, so as to construct a graph weight matrix and a tensor locality preserving projection model; obtain a projection matrix of each dimension of the corresponding tensor data block by means of the tensor locality preserving projection model; and finally, utilize a low-dimensional projection matrix to obtain a training set and a test set which are represented by three-dimensional low dimensions, expand the training set and the test set into a form of column vectors according to a feature dimensionality, input extracted low-dimensional features into a support vector machine classifier for classification, to determine a class of the test set to obtain a determination result, and evaluate the performance of feature extraction by a classification effect of determination results.

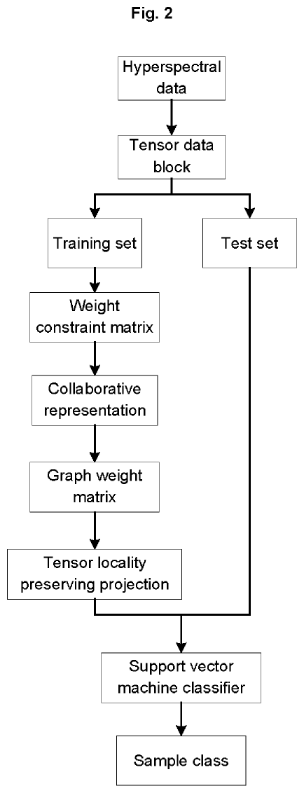

With reference to FIG. 2, the embodiment of the present disclosure specifically includes:

At step 1, in an optional embodiment, the input original hyperspectral data H̅ ∈ R^{A×B×D} is divided into third-order tensor blocks according to the size of the square sliding window, and the tensor data blocks are divided into a training set and a test set in a certain proportion, where A and B represent two spatial dimensions of the hyperspectral data respectively, D represents a spectral dimension of the hyperspectral data, and R represents a real number space.

The size of the square sliding window is configured as w×w, the third-order tensor data block obtained by cutting may be represented as K̅ ∈ R^{w×w×D}, the training set obtained by division in proportion consists of N samples including C classes, and is represented as X̅=[x̅₁, x̅₂, . . . , x̅_{N}] ∈ R^{w×w×D×N}, and an l-th class of samples is represented as X̅^{l}=[x̅₁^{l}, x̅₂^{l}, . . . , x̅_{N}_{₁}^{l}] ∈ R^{w×w×D×N}^{ₗ}, l=1, 2, . . . , C,

$$N = {\sum }_{l = 1}^{C} {N}_{l} ,$$

x̅ᵢ representing an i-th data block in the training set, 1≤i≤N, Nₗ representing the number of an l-th class of training samples, and x̅ᵢ^{l} representing an i-th data block in the l-th class of training samples.

The test set consists of M samples, and is represented as Y̅=[y̅₁, y̅₂, . . . , y̅_{M}] ∈ R^{w×w×D×M}, y̅ⱼ representing a j-th test data block, 1≤j≤M.

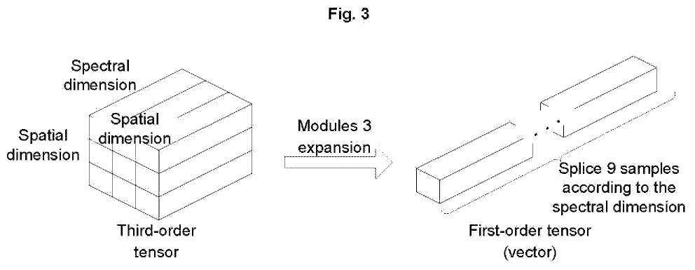

With reference to FIG. 3, at step 2, in construction of the diagonal weight constraint matrix, the data blocks in the training set obtained by division in proportion are divided into C data sub-sets according to classes, an l-th data sub-set is X̅^{l}, and has Nₗ samples in total, an i-th sample x̅ᵢ^{l} the l-th data sub-set X̅^{l} is expanded into a form of a vector xᵢ^{l} according to a module three and has a Euclidean distance Γᵢⱼ^{l}=∥xᵢ^{l}−xⱼ^{l}∥₂ from a j-th sample in the l-th data sub-set, and (Nₗ−1) Euclidean distances are finally obtained, 1≤j≤Nₗ, j≠i, ∥·∥₂ representing as an L2 norm. The embodiment of the present disclosure uses an within-class representation method, and therefore, in response to the Euclidean distance Γᵢⱼ^{l} being computed, the Euclidean distance between xᵢ^{l} and itself is not included. The (Nₗ−1) Euclidean distances are taken as diagonal elements of a symmetric matrix, to construct an l-th class of diagonal weight constraint matrix Γ^{l′} ∈ R^{(N}^{ₗ}^{-1)×(N}^{ₗ}⁻¹⁾ as follow formula:

$${Γ}^{{l}^{′}} = [ \begin{matrix}{Γ}_{i 1}^{l} & 0 & … & 0 \\ 0 & {Γ}_{i 2}^{l} & … & 0 \\ ⋮ & ⋮ & ⋱ & ⋮ \\ 0 & 0 & … & {Γ}_{{iN}_{l}}^{l}\end{matrix} ]$$

At step 3, in construction of the collaborative representation model with a weight constraint, a L2 norm is used to achieve sparsity constraint of a representation coefficient of the training sample xᵢ^{l}, and to reduce complexity of the model, and moreover, representation capability of the representation coefficient is improved by the weight constraint matrix. The embodiment of the present disclosure uses the within-class representation method. That us, a training sample xᵢ^{l} only uses the same l-th class samples for representation learning, and the collaborative representation model with a weight constraint is constructed as follow formula:

αᵢ^{l}=arg min∥xᵢ^{l}−X^{l′}αᵢ^{l}∥₂²+λ∥Γ^{l′}αᵢ^{l}∥₂²,

where arg min represents a minimum value of an objective function, X^{l′}=[x₁^{l}, . . . , xᵢ₋₁^{l}, xᵢ₊₁^{l}, . . . , x_{N}_{ᵢ}^{l}] ∈ R^{Dw}^{²}^{×(N}^{ₗ}⁻¹⁾ represents a dictionary, in which elements include (Nₗ−1) samples except for xᵢ^{l} and a dimension of the sample is Dw², ∥·∥₂² represents a square of the L2 norm of the matrix, αᵢ^{l} represents the representation coefficient in response to xᵢ^{l} taking X^{l′} as the dictionary, and λ represents a regularization parameter.

At step 4, the collaborative representation model with a weight constraint is solved. The collaborative representation model is based on the L2 norm, and an optimal solution αᵢ^{l}=(X^{l′T}X^{l′}+λ²Γ^{l′T}Γ^{l′})⁻¹X^{l′T}xᵢ^{l} of the representation coefficient αᵢ^{l} may be obtained by means of derivation, where T represents a transpose of the matrix, and (·)⁻¹ represents an inverse of the matrix.

At step 5, in construction of the graph weight matrix, according to the representation coefficient αᵢ^{l}=[α_{i,1}^{l}, α_{i,2}^{l}, . . . , α_{i,N}_{ₗ}₋₁^{l}], a graph weight coefficient of the l-th class is obtained, which is represented as follow formula:

$${( {W}_{l} )}_{i , j} = \{ \begin{matrix}0 , & i = j \\ {α}_{i , j}^{l} & i > j \\ {α}_{i , j - 1}^{l} & i < j\end{matrix}$$

finally, the graph weight matrix constructed by the training samples is as follow formula:

$$W = [ \begin{matrix}{W}_{1} & 0 & … & 0 \\ 0 & {W}_{2} & … & 0 \\ ⋮ & ⋮ & ⋱ & ⋮ \\ 0 & 0 & … & {W}_{C}\end{matrix} ] ,$$

where Wᵢ represents an i-th class of intra-class weight matrix, i=1,2, . . . , C, and C represents the total number of classes in hyperspectral data.

At step 6, during solving the projection matrix, the embodiment uses the tensor locality preserving projection algorithm to solve projection of three dimensions in the hyperspectral data block, which is shown in the following formulas:

$$min {\sum }_{i , j} {‖ {\overline{X}}_{1 , ( n )} {\times }_{n} {U}_{n} - {\overline{X}}_{j , ( n )} {\times }_{n} {U}_{n} ‖}^{2} {W}_{i , j}$$

$$min Tr ( {U}_{n} ( {\sum }_{ij} ( {{X}^{︵}}_{i}^{n} - {{X}^{︵}}_{j}^{n} ) {( {{X}^{︵}}_{i}^{n} - {{X}^{︵}}_{j}^{n} )}^{T} {W}_{ij} ) {U}_{n}^{T} )$$

$$s . t . Tr ( {U}_{n} ( {\sum }_{ij} {{X}^{︵}}_{i}^{n} {{X}^{︵}}_{i}^{nT} {C}_{ii} ) {U}_{n}^{T} ) = 1$$

where min represents a minimum value of an objective function, Σ represents summation operation, X̅ᵢ₍ₙ₎ represents operation of an i-th data block according to a n-mode, ×ₙ represents multiplication of the n-mode, Uₙ represents the n-mode projection matrix, W_{i,j} represents an element of the graph weight matrix having a row number being i and a column number being j, Tr(·) represents a trace of the matrix, and \hat{X}ᵢⁿ represents expansion of the n-th modulus of the i-th data block.

At step 7, during computation of the low-dimensional features of the training set and the test set, the low-dimensional features \hat{X}=X̅×₁U₁×₂U₂×₃U₃ and Ŷ=Y̅×₁U₁×₂U₂×₃U₃ of the training set and the test set are computed according to projection matrices U₁, U₂ and U₃ on three dimensions obtained in step 6,

where \hat{X} and Ŷ represents the low-dimensional features of the training set X̅ and the test set Y̅.

At step 8, the support vector machine classifier is used to compute classes of samples of the test set after feature extraction, the low-dimensional features \hat{X} of the training set are used to train the support vector machine classifier, and then, the low-dimensional features Ŷ of the test set are classified, so as at least to test performance of a feature extraction method according to accuracy of classification of the classes of the samples of the test set.

The objective, the technical solution and the beneficial effects of the present disclosure are further described in detail by means of the above mentioned embodiments, and it should be understood that what is mentioned above is only the particular embodiment of the present disclosure and is not intended to limit the present disclosure. Any modifications, equivalent substitutions, improvements, etc. made within the spirit and principles of the present disclosure are intended fall within the scope of protection of the present disclosure.

What is claimed is:

1. A method for feature extraction of a remote sensing images based on tensor collaborative graph discriminant analysis, comprising:
setting a size of a square sliding window, taking a first pixel of input original hyperspectral data as a starting point, and taking each of pixels as a center for intercepting a three-dimensional tensor data block;
dividing experimental data into a training set and a test set in proportion according to three-dimensional tensor data blocks, and expanding each of the three-dimensional tensor data blocks into a column vector according to a spectral dimension;
computing a Euclidean distance between a current training pixel and each class of training data, to construct a diagonal weight constraint matrix;
configuring a L2 norm collaborative representation model with a weight constraint, to compute a representation coefficient of the current training pixel under each class of training data, to construct a graph weight matrix and a tensor locality preserving projection model;
acquiring a projection matrix of each dimension of each of the three-dimensional tensor data blocks according to the tensor locality preserving projection model; and
utilizing a low-dimensional projection matrix to obtain a training set and a test set which are represented by three-dimensional low dimensions, expanding the training set and the test set into a form of column vectors according to a feature dimension, inputting extracted low-dimensional features into a support vector machine classifier for classification, to determine a class of the test set, and evaluating, by a classification effect, performance of feature extraction.

2. The method for feature extraction of the remote sensing images based on the tensor collaborative graph discriminant analysis as claimed in claim 1, wherein the original hyperspectral data H̅ ∈ R^{A×B×D} is cut into third-order tensor blocks according to the size of the square sliding window, A and B respectively represents two spatial dimensions of the original hyperspectral data, D represents a spectral dimension of the original hyperspectral data, and R represents a real number space.

3. The method for feature extraction of the remote sensing images based on the tensor collaborative graph discriminant analysis as claimed in claim 1, wherein the size of the square sliding window is configured as w×w, one third-order tensor data block is represented as K̅ ∈ R^{w×w×D}, the training set obtained by division in proportion consists of N samples comprising C classes, and is represented as X̅=[x̅₁, x̅₂, . . . , x̅_{N}] ∈ R^{w×w×w×D×N}, and an l-th class of samples is represented as X̅^{l}=[x̅₁^{l}, x̅₂^{l}, . . . , x̅_{N}_{ₗ}^{l}] ∈ R^{w×w×D×N}^{ₗ}, l=1, 2, . . . , C,
$$N = {\sum }_{l = 1}^{C} {N}_{l} ,$$
x̅ᵢ represents an i-th data block in the training set, 1≤i≤N, Nₗ represents the number of an l-th class of training samples, and x̅ᵢ^{l} represents an i-th data block in the l-th class of training samples.

4. The method for feature extraction of the remote sensing images based on the tensor collaborative graph discriminant analysis as claimed in claim 3, wherein the test set obtained by division in proportion consists of M samples, and is represented as Y̅=[y̅₁, y̅₂, . . . , y̅_{M}] ∈ R^{w×w×D×M}, y̅ⱼ represents a j-th test data block, 1≤j≤M.

5. The method for feature extraction of the remote sensing images based on the tensor collaborative graph discriminant analysis as claimed in claim 1, wherein in construction of the diagonal weight constraint matrix, data blocks in the training set obtained by division in proportion are divided into C data sub-sets according to classes, an l-th data sub-set is X̅^{l}, and has Nₗ samples in total, an i-th sample x̅ᵢ^{l} in the l-th data sub-set X̅^{l} is expanded into a form of a vector xᵢ^{l} according to a modulus 3 and has a Euclidean distance Γᵢⱼ^{l}=∥xᵢ^{l}−xⱼ^{l}∥₂ from a j-th sample in the l-th data sub-set, and (Nₗ−1) Euclidean distances are obtained, 1≤j≤Nₗ, j≠i, ∥·∥₂ represents an L2 norm.

6. The method for feature extraction of the remote sensing images based on the tensor collaborative graph discriminant analysis as claimed in claim 1, wherein in response to the Euclidean distance Γᵢⱼ^{l} being computed without containing the Euclidean distance between xᵢ^{l} and xᵢ^{l}, and the (Nₗ=1) Euclidean distances are taken as diagonal elements of a symmetric matrix, to construct an l-th class of diagonal weight constraint matrix Γ^{l′} ∈ R^{(N}^{ₗ}^{-1)×(N}^{ₗ}⁻¹⁾ as follows:
$${Γ}^{{l}^{′}} = [ \begin{matrix}{Γ}_{i 1}^{l} & 0 & … & 0 \\ 0 & {Γ}_{i 2}^{l} & … & 0 \\ ⋮ & ⋮ & ⋱ & ⋮ \\ 0 & 0 & … & {Γ}_{{iN}_{l}}^{l}\end{matrix} ] .$$

7. The method for feature extraction of the remote sensing images based on the tensor collaborative graph discriminant analysis as claimed in claim 1, wherein in a construction process of the L2 norm collaborative representation model with weight constraint, an L2 norm is used for achieving sparsity constraint of a representation coefficient of the training sample xᵢ^{l} and reducing complexity of the model, improving representation capability of the representation coefficient by the diagonal weight constraint matrix, an within-class representation method is used, and a training sample xᵢ^{l} uses the same l-th class samples for representation learning, and the L2 norm collaborative representation model with weight constraint is constructed as follows:
αᵢ^{l}=arg min∥xᵢ^{l}−X^{l′}αᵢ^{l}∥₂²+λ∥Γ^{l′}αᵢ^{l}∥₂²,
wherein arg min represents a minimum value of an objective function, X^{l′}=[x₁^{l}, . . . , xᵢ₋₁^{l}, xᵢ₊₁^{l}, . . . , x_{N}_{ₗ}^{l}] ∈ R^{Dw}^{²}^{×(N}^{ₗ}⁻¹⁾ represents a dictionary, in which elements include (Nₗ−1) samples except for xᵢ^{l} and a dimension of the sample is Dw², ∥·∥₂² represents a square of the L2 norm of the matrix, αᵢ^{l} represents the representation coefficient in response to xᵢ^{l} taking X^{l′} as the dictionary, and λ represents a regularization parameter.

8. The method for feature extraction of the remote sensing images based on the tensor collaborative graph discriminant analysis as claimed in claim 1, wherein the L2 norm collaborative representation model is based on a L2 norm, and an optimal solution αᵢ^{l}=(X^{l′T}X^{l′}+λ²Γ^{l′T}Γ^{l′})⁻¹X^{l′T}xᵢ^{l} of the representation coefficient αᵢ^{l} is obtained by means of derivation, wherein T represents a transpose of the matrix, and (·)⁻¹ represents an inverse of the matrix.

9. The method for feature extraction of the remote sensing images based on the tensor collaborative graph discriminant analysis as claimed in claim 1, wherein during solving the projection matrix, the tensor locality preserving projection method is used for solving projection of three dimensions in the corresponding tensor data block, which is shown in the following expressions:
$$min {\sum }_{i , j} {‖ {\overline{X}}_{1 , ( n )} {\times }_{n} {U}_{n} - {\overline{X}}_{j , ( n )} {\times }_{n} {U}_{n} ‖}^{2} {W}_{i , j}$$
$$min Tr ( {U}_{n} ( {\sum }_{ij} ( {{X}^{︵}}_{i}^{n} - {{X}^{︵}}_{j}^{n} ) {( {{X}^{︵}}_{i}^{n} - {{X}^{︵}}_{j}^{n} )}^{T} {W}_{ij} ) {U}_{n}^{T} )$$
$$s . t . Tr ( {U}_{n} ( {\sum }_{ij} {{X}^{︵}}_{i}^{n} {{X}^{︵}}_{i}^{nT} {C}_{ii} ) {U}_{n}^{T} ) = 1$$
wherein min represents a minimum value of an objective function, Σ represents summation operation, X̅_{i,(n)} represents operation of an i-th data block according to a n-mode, ×ₙ represents multiplication of the n-mode, Uₙ represents the n-mode projection matrix, W_{i,j} represents an element of the graph weight matrix with a row number being i and a column number being j, Tr(·) represents a trace of the matrix, and \hat{X}ᵢⁿ represents expansion of the n-th modulus of the i-th data block.

10. The method for feature extraction of the remote sensing images based on the tensor collaborative graph discriminant analysis as claimed in claim 1, wherein during computation of the low-dimensional features of the training set and the test set, the low-dimensional features \hat{X}=X̅×₁U₁×₂U₂×₃U₃ and Ŷ=Y̅×₁U₁×₂U₂×₃U₃ of the training set and the test set which are represented by the three-dimensional low-dimensions are computed according to projection matrices U₁, U₂ and U₃ on three dimensions, wherein \hat{X} and Ŷ respectively represents the low-dimensional features of the training set X̅ and the test set Y̅ which are represented by the three-dimensional low dimensions.
